(19) United States
(12) Patent Application Publication
(10) Pub. No.: US 2008/0102783 A1
(43) Pub. Date: May 1, 2008

(54) METHOD AND COMMUNICATION UNIT FOR INIDICATING URGENCY OF A COMMUNICATION

(75) Inventor: Valentin M. Bustamante, Gilbert, AZ (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/554,718

(22) Filed: Oct. 31, 2006

(51) Int. Cl. H04M 11/04

(52) U.S. Cl. 455/404.1

(57) ABSTRACT

The invention concerns a communication unit (102) and a method (200) of indicating urgency of a communication at the communication unit (102). In one arrangement, the method can include the steps of receiving (204) a first call from a caller (108), receiving (212) a subsequent second call from the caller, and if the second call meets a predefined parameter, increasing (216) an alert level to provide an indication or urgency or to locate the communication unit.

### BACKGROUND OF THE INVENTION

1. Field of the Invention

This invention relates in general to communications and more particularly, to a method and system for indicating urgency of a communication.

2. Description of the Related Art

In the last few years, the field of communications has experienced tremendous growth. As a result, people now have multiple options of communication. For example, a person can now be contacted for a phone call on a mobile phone, a landline phone, a palmtop and a Personal Digital Assistant. Along with this increase in options, there has also been a corresponding rise in value-added services. An example of this is the caller line identification package that allows a person to see the identity of the caller. However, there is no service that allows for the person to see the urgency or eagerness of the caller.

Consider a scenario in which a person has met with an accident and wants to contact a friend urgently. Let us assume that the friend is in a meeting when the person calls and does not attend the call. However, if the person involved in the accident were able to convey the urgency of the call, the friend would not ignore it.

### SUMMARY OF THE INVENTION

The present invention concerns a method for indicating urgency of a communication at a communication unit. The method can include steps of receiving a first call from a caller, receiving a subsequent second call from the caller, and increasing an alert level to provide an indication of urgency if the second call meets a predefined parameter. The method can also include the step of locating the communication unit. In one arrangement, the predefined parameter can be the second call arriving at the communication unit within a predetermined amount of time. In another arrangement, the predefined parameter can be a proper password entered by the caller after the first call. In yet another arrangement, the predefined parameter can be the caller being an entry in a pre-approved list of the communication unit. The method can also include storing call details of the first call in the communication unit. The call details can include identity of the caller and time of the call. The method can also include calculating time gap between the first call and the second call and comparing the time gap with the predetermined amount of time. In one arrangement, the first call can be transferred to an answering system and the caller can be notified that the alert level will be increased if a subsequent second call from the caller meets the predefined condition.

In one arrangement, increasing the alert level to provide the indication of the urgency of the communication can include changing a silent mode of the communication unit to a vibration mode. In another arrangement, increasing the alert level to provide an indication of the urgency of the communication can include changing the vibration mode of the communication unit to a ringing mode. In another arrangement, increasing the alert level to provide an indication of the urgency of the communication can include increasing a volume of a ring-tone of the communication unit. In yet another arrangement, increasing the alert level to provide an indication of the urgency of the communication can include changing a style of the ring-tone of the communication unit.

The present invention also concerns a communication unit. The communication unit can include a receiver, a processor, and an alert mechanism. The communication unit can also include suitable software and circuitry for performing any of the steps recited above. The receiver can receive a first call from a caller and a subsequent second call from the caller. The processor can be coupled to the receiver and can be programmed to modify a manner in which a user is alerted if the second call meets a predefined parameter. The alert mechanism can alert the user of the communication unit and be coupled to the processor. In one arrangement, the predefined parameter can be the second call arriving at the communication unit within a predetermined amount of time. In another arrangement, the predefined parameter can be a proper password entered by the caller after the first call. In yet another arrangement, the predefined parameter can be the caller being an entry in a pre-approved list of the communication unit.

In addition, the communication unit also includes a memory module that can store call details of the first call. The call details can include identity of the caller and time of the call. The processor can also be programmed to transfer the first call to an answering system. The answering system can notify the caller that the alert level will be modified if the second call from the caller meets the predefined parameter. The processor can include a comparator module that can calculate time gap between the first call and the second call and compare the time gap with the predetermined amount of time.

In an arrangement, the alert mechanism can be a ringer. The alert mechanism can be modified by increasing the volume of the ringer or by changing a style of a ring-tone that the ringer plays. In another arrangement, the ringer can be modified by adjusting the state of the ringer from a silent mode to a ringing mode. In yet another arrangement, the alert mechanism can be a vibrator and can be modified by adjusting the state of the vibrator from a silent mode to a vibrate mode.

The present invention also concerns a machine readable storage having stored thereon a computer program. The computer program can include a plurality of code sections executable by a communication unit. The computer program can cause the communication unit to receive a first call from a caller and receive a subsequent second call from the caller. Further, the computer program can cause the communication unit to increase an alert level of the communication unit to provide an indication of the urgency of the call or to locate the communication unit, if the second call meets a predefined condition. The computer program can also cause the communication unit to perform any of the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a communication system, in accordance with various embodiments of the inventive arrangements;

FIGS. 2 and 3 illustrate an example of a method for indicating urgency of a communication at a communication unit, in accordance with an embodiment of the inventive arrangements; and

FIG. 4 illustrates an example of a block diagram of a communication unit, in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality” as used herein, is defined as two or more than two. The term “another” as used herein, is defined as at least a second or more. The terms “including” and/or “having” as used herein, are defined as comprising (i.e., open language). The term “coupled” or “operatively coupled” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. A processor can be any component or group of components capable of executing a set of instructions. In addition, a communication unit can be defined as any unit capable of at least receiving a communication signal.

The invention concerns a method and a communication unit for indicating urgency of a communication. In one arrangement, the method can include the steps of receiving a first call from a caller, receiving a subsequent second call from the caller, and increasing an alert level to provide an indication of urgency if the second call meets a predefined parameter. Such a process can increase the chances that a person being called can become aware of the incoming call. Moreover, this technique can be used to help a person locate a misplaced communication unit.

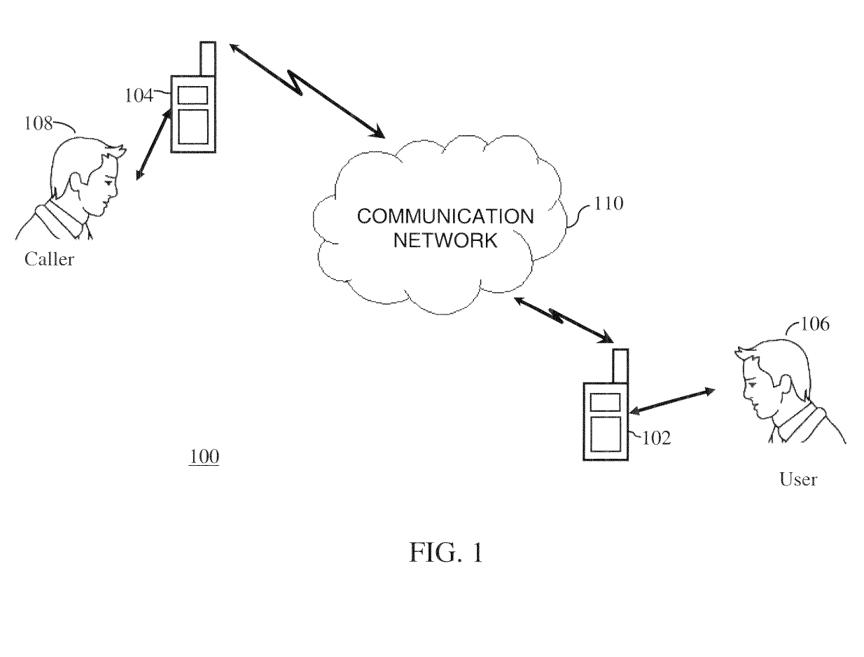

Referring to FIG. 1, an example of a communication system 100 is shown. In one embodiment, the communication system 100 can include a communication unit 102 and a communication unit 104. This invention is described below with the arrangement that the communication unit 104 is trying to establish a call with the communication unit 102. The communication system 100 can further include a user 106 of the communication unit 102 and a caller 108 of the communication unit 104. The caller 108 can be a person (or a machine) that needs to contact the user 106 urgently. For example, the caller 108 might have been involved in an accident and requires help from the user 106. In other words, the invention is described with the scenario that the caller 108 is trying to establish contact with the user 106.

As an example, one or both of the communication unit 102 and the communication unit 104 can be wireless communication units, such as mobile phones, and can communicate with each other through a communication network 110. Of course, one or both of the communication unit 102 and the communication unit 104 can be wired communication units, such as landline phones that can communicate with one another through the communication network 110. As such, the communication network 110, as those of skill in the art will appreciate, can be configured to support both wired and wireless communication. The communication network 110 can be configured to transmit and receive any suitable type of communication signals, including voice and data signals.

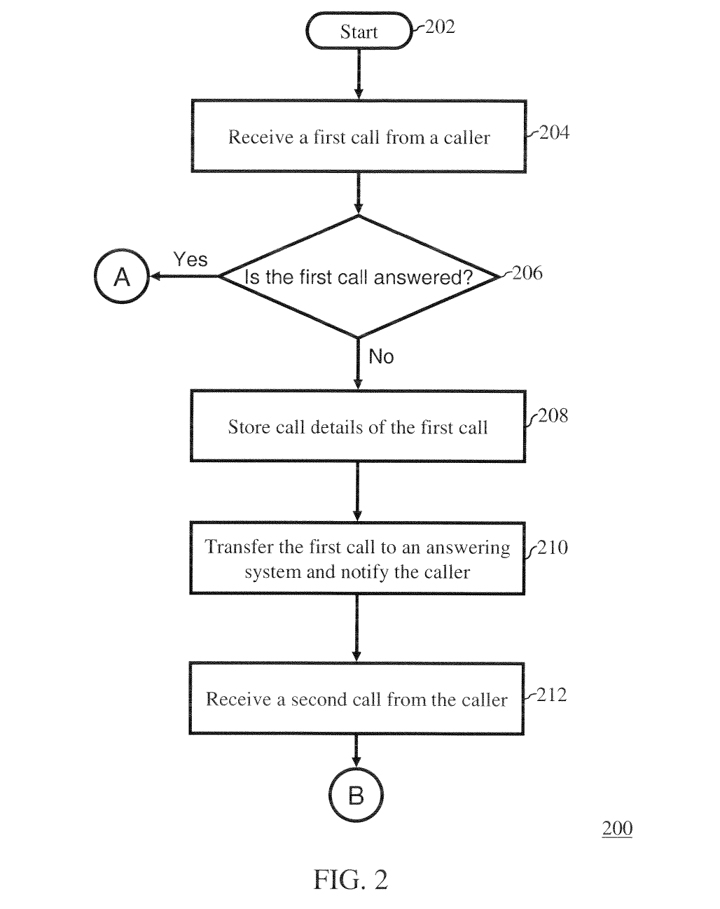

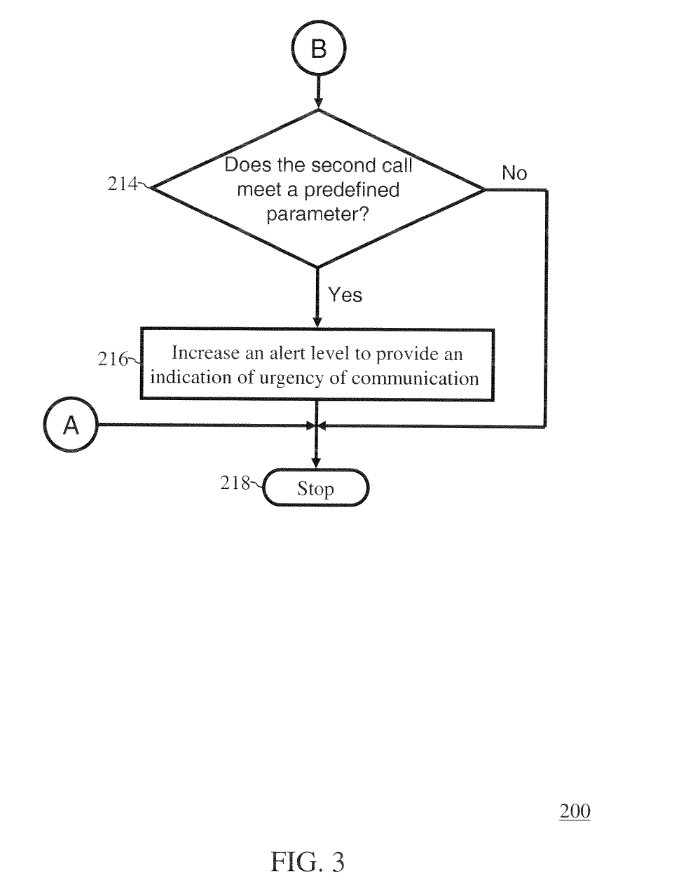

Referring to FIGS. 2 and 3, a method 200 for indicating urgency of a communication at a communication unit is shown. To describe the method 200, reference will be made to FIG. 1, although it is understood that the method 200 can be implemented in any other suitable device or system. Moreover, the invention is not limited to the order in which the steps are listed in the method 200. In addition, the method 200 can contain a greater or fewer numbers of steps than those shown in FIGS. 2 and 3.

In one arrangement, the method 200 can include one or more method steps for indicating urgency of a communication to the user 106 when the caller 108 calls the communication unit 102. At step 202, the method 200 can start. At step 204, the communication unit 102 can receive a first call from the caller 108. A call is an attempt to establish a communication link between two or more communication units. The communication link can be configured to transmit and receive any suitable type of communication signal, including voice and data signals. In other words, the method 200 is applicable to both voice calls and data calls. Further, when the caller 108 attempts to establish a communication link with the user 106, the communication unit 102 can issue an alert. The alert can be in the form of an audio alert, a visual alert or a physical alert based on the preference of the user 106. An example of an audio alert is a ringing alert. Similarly, a display of the communication unit 102 lighting up is an example of the visual alert, while the communication unit 102 vibrating is an example of the physical alert. The user 106 can choose the alert that is most suitable at a given point of time. For example, in a business meeting the user 106 can choose the vibrating alert.

Furthermore, the caller 108 can get an acknowledgement from the communication network 110 when the communication unit 102 issues an alert. The acknowledgment can be a ring or a beep that the caller 108 gets to hear. In other words, the ringing tone that the caller 108 hears may be the acknowledgement that the communication unit 102 of the user 106 is issuing an alert. The user 106, upon being alerted by the communication unit 102, can choose to answer the call or ignore the call. Further, it is possible that the user 106 is not alerted by the communication unit 102. An example of this scenario is the user 106 not being present in the same room as the communication unit 102. Another possible example of this scenario is the user 106 choosing an inappropriate alerting mode, and subsequently not knowing when the communication unit 102 is issuing an alert.

At step 206, it can be determined whether the first call is answered by the user 106 of the communication unit 102. If the first call is answered, as determined at step 206, the method 200 can end at step 218 of FIG. 3 (through jump circle A). If however, the first call is not answered, as determined at step 206, then call details of the first call can be stored in the communication unit 102 at step 208. In one embodiment, the call details of the first call can include the identity of the caller 108 and time at which the first call was received at the communication unit 102. Further, the identity of the caller 108 can include name of the caller 108 and phone number of the caller 108.

At step 210, the first call can be transferred to an answering system and the caller 108 can be notified as to how to indicate to the user 106 the urgency of the communication. In one embodiment, the answering system can convey to the caller 108 that the alert level of the alert mechanism will be increased if the subsequent second call from the caller 108 meets a predefined parameter. In one embodiment, the predefined parameter can be the second call arriving at the communication unit 102 within a predefined amount of time. In one arrangement of this embodiment, the predefined amount of time can be set by the manufacturer of the communication unit 102. In another arrangement, the predefined amount of time can be set by the user 106 of the communication unit 102.

In another embodiment, the predefined parameter can be a password entered by the caller 108. In this embodiment, the user 106 of the communication unit 102 can provide the password to a set of callers. If the caller 108 is able to input the proper password then the urgency of the communication will be indicated to the user 106 of the communication unit 102 when the caller 108 makes the second call. To be clear, the process of entering the password is not necessarily tied to the step of transferring the caller 108 to the answering system. In one arrangement of this embodiment, the caller 108 can input the password by entering a predefined combination of keystrokes on a dial-pad of the communication unit 104. In another arrangement, the caller 108 can input the password by saying the proper password into a microphone (not shown) of the communication unit 104. The proper password can be entered by the caller 108, when the caller 108 makes the second call to the user 106 of the communication unit 102. The proper password can also be entered by the caller 108 during the first call as well.

In yet another embodiment, the predefined parameter can be the caller 108 being an entry in a pre-approved list of the communication unit 102. In this embodiment, the pre-approved list can be a contact list or a list of entries in the phone book of the communication unit 102. Further, the pre-approved list can include friends, family members, and other important callers. In this embodiment, if the caller 108 belongs to the pre-approved list of callers then the subsequent second call from the caller 108 can have an increased alert level. Although several examples of a predefined parameter have been described above, it is important to note that the invention is not so limited, as any other suitable criteria can serve as a predefined parameter.

At step 212, a second call can be received from the caller 108 of the communication unit 104. Turning to FIG. 3 through jump circle B, at step 214, it can be determined whether the second call meets the predefined parameter. In an embodiment, the second call can meet the predefined parameter if the second call is received before the predefined amount of time elapses. Alternatively, the second call can meet the predefined parameter if the caller 108 enters the proper password or if the caller 108 belongs to the pre-approved list. If the second call meets the predefined parameter, as determined at step 214, the alert level can be increased to indicate the urgency of the communication to the user 106 of the communication unit 102 at step 216.

In one embodiment, increasing the alert level can include changing the alert mode of the communication unit 102. In one arrangement of this embodiment, the silent mode of the communication unit 102 can be changed to the vibration mode. In another arrangement, the vibration mode of the communication unit 102 can be changed to the ringing mode. In another embodiment, increasing the alert level can include increasing the volume of a ring-tone of the communication unit 102. In this embodiment, the volume of the ring-tone of the communication unit 102 can have more than one level. Increasing the volume can include increasing a current level of the volume of the ring-tone to a higher level. In yet another embodiment, increasing the alert mechanism can include changing a style of a ring-tone of the communication unit 102. In this embodiment, changing the style of the ring-tone can include changing a conventional ring-tone to a Motion Picture Expert Group Layer 3 (MP3) enabled ring-tone. Changing the style of the ring-tone can also include changing one MP3-enabled ring-tone to another MP3 enabled ring-tone. If the second call does not meet the predefined parameter, as determined at step 214, the method can end at step 218.

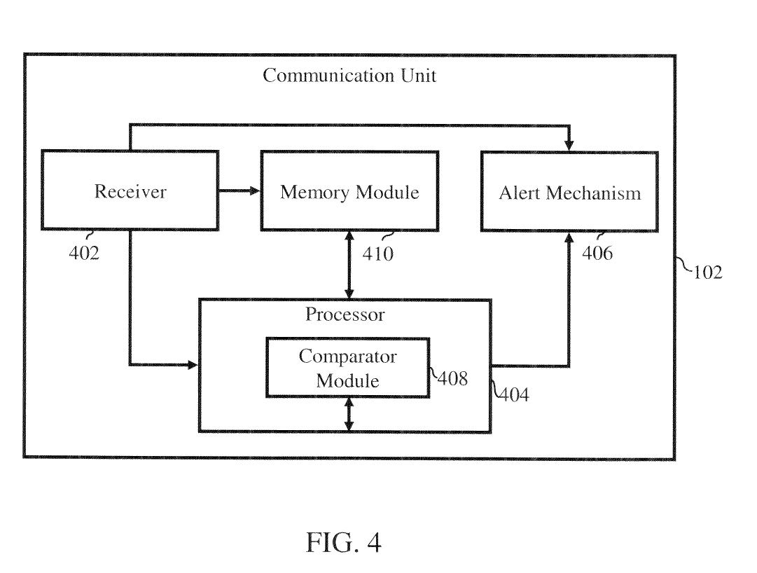

Referring to FIG. 4, an example of a block diagram of a communication unit 102 is shown. Those of skill in the art will appreciate that the communication unit 102 may include all or even a fewer number than the components shown in FIG. 4. Also, those of skill in the art will understand that the communication unit 102 may include additional components that are not shown here but are not germane to the operation of the communication unit 102 in accordance with the inventive arrangements.

Here, the communication unit 102 can include a receiver 402, a processor 404, an alert mechanism 406, and a memory module 410. The communication unit 102 may also include a user interface (not shown in FIG. 4). The user interface can include any suitable number and type of controls or components that enable the user 106 to interact with the communication unit 102, which includes making and receiving calls. The user interface may also include one or more microphones, one or more keypads or other button arrangements and one or more displays.

The receiver 402 can receive the first call and the subsequent second call from the caller 108. The receiver 402 can be configured to receive and transmit any suitable type of communication signal, including voice and data signals. Further, when the receiver 402 receives the calls, the alert mechanism 406 can issue an alert. The alert can be in the form of an audio alert, a visual alert or a physical alert based on the preference of the user 106. An example of an audio alert is a ringing alert. Similarly a display (not shown) of the communication unit 102 lighting up is an example of the visual alert while the communication unit 102 vibrating is an example of the physical alert. The user 106 chooses the alert that is most suitable at a given point of time. For example, in a business meeting the user 106 might choose the vibrating alert. The alert mechanism 406 can alert the user 106 by using the audio alert, the visual alert or the physical alert.

Furthermore, the caller 108 can get an acknowledgement from the communication network 110 when the alert mechanism 406 issues an alert. The acknowledgment can be a ring or a beep which the caller 108 gets to hear. In other words, the ringing tone that the caller 108 hears is the acknowledgement that the alert mechanism 406 is issuing an alert. The user 106, upon being alerted by the alert mechanism 406, can choose to answer the call or ignore the call. Further, it is possible that the user 106 is not alerted by the alert mechanism 406. An example of this scenario is the user 106 not being present in the same room as the communication unit 102. Another possible example of this scenario is the user 106 choosing an inappropriate alerting mode, and subsequently not knowing when the communication unit 102 is issuing an alert.

If the first call is not answered by the user 106 of the communication unit 102, call details of the first call can be stored in the memory module 410. The call details can include the identity of the caller 108 and time at which the call was received at the communication unit 102. Further, the identity of the caller 108 can include the name of the caller 108 and phone number of the caller 108. After the call details are stored in the memory module 410, the processor 404 can transfer the first call to an answering system. The processor 404 can be programmed to transfer the first call to an answering system. The answering system can notify the caller 108 that the alert level will be modified if the second call from the caller 108 meets the predefined parameter.

The processor 404, for example, can also provide processing capabilities for the various functions of the communication unit 102. As an example, the processor 404 can modify a manner in which the alert mechanism 406 can issue alerts. In one arrangement, the processor 404 can include a comparator module 408. The comparator module 408 can calculate the time gap between the first call and the second call. The comparator module 408 can also compare the time gap with the predetermined amount of time. In one arrangement, the predefined amount of time can be set by the manufacturer of the communication unit 102. In another arrangement, the predefined amount of time can be set by the user 106 of the communication unit 102. In another arrangement, the comparator module 408 can be a part of communication unit 102 rather than being a part of the processor 404.

The alert mechanism 406, for example, can be coupled to the processor 404 and can alert the user 106 of the communication unit 102. The alert mechanism 406 can be a ringer and can be modified, to indicate the urgency of the call or to help the user 106 find the communication unit 102. The ringer can be modified by increasing volume of the ringer or by changing a style of a ring-tone that the ringer plays or by adjusting the state of the ringer from a silent mode to a ringing mode. The alert mechanism 406 can also be a vibrator and can be modified, to indicate the urgency of the call or to help the user 106 find the communication unit 102, by adjusting the state of vibrator from a silent mode to a vibrate mode. The memory module 410, for example, can store the call details of the first call and the second call. The call details can include the identity of the caller 108 and time at which the call was received at the communication unit 102. Further, the identity of the caller 108 can include the name of the caller 108 and phone number of the caller 108.

Various embodiments of the inventive arrangements have the advantage of indicating urgency of a communication at a communication unit. The entire control of the service lies with the user of the communication unit. The user can select callers who the user wants to use the service. The user does this by providing a password to the callers. Alternatively, the user can select a list of callers for who the service will be active from the phonebook of the communication unit. Hence, the user will not be troubled by calls from callers other than the selected callers. Furthermore, the various embodiments of the inventive arrangement can be used for locating lost communication unit.

Where applicable, the present invention can be realized in hardware, software or a combination of hardware and software. Any kind of computer system or other apparatus adapted for carrying out the methods described herein are suitable. A typical combination of hardware and software can be a mobile communication unit with a computer program that, when being loaded and executed, can control the mobile communication unit such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for indicating urgency of a communication at a communication unit, the method comprising:
receiving a first call from a caller;
receiving a subsequent second call from the caller; and
if the second call meets a predefined parameter, increasing an alert level to provide an indication of the urgency of the communication or to locate the communication unit.

2. The method according to claim 1, wherein the first call and the second call are received at the communication unit and the predefined parameter is (1) the second call arriving at the communication unit within a predetermined amount of time, (2) a proper password entered by the caller after the first call or (3) the caller being an entry in a pre-approved list of the communication unit.

3. The method according to claim 2, wherein the pre-approved list is a contact list of the communication unit.

4. The method according to claim 2, further comprising: (1) calculating a time gap between the first call and the second call and (2) comparing the time gap with the predetermined amount of time.

5. The method according to claim 1, further comprising storing call details of the first call, wherein the call detail comprises identity of the caller and time of call.

6. The method according to claim 1, further comprising:
transferring the first call to an answering system; and
notifying the caller that the alert level will be increased if the second call from the caller meets the predefined parameter.

7. The method according to claim 1, wherein increasing the alert level to provide an indication of the urgency of the communication comprises changing a silent mode of the communication unit to a vibration mode.

8. The method according to claim 1, wherein increasing the alert level to provide an indication of the urgency of the communication comprises changing a vibration mode of the communication unit to a ringing mode.

9. The method according to claim 1, wherein increasing the alert level to provide an indication of the urgency of the communication comprises increasing a volume of a ring-tone of the communication unit.

10. The method according to claim 1, wherein increasing the alert level to provide an indication of the urgency of the communication comprises changing a style of a ring-tone of the communication unit.

11. A communication unit, comprising:
a receiver that receives a first call from a caller and a subsequent second call from the caller;
an alert mechanism that alerts the user of the communication unit;
a processor coupled to the receiver and the alert mechanism, wherein the processor is programmed to:
modify a manner in which a user is alerted through the alert mechanism if the second call meets a predefined parameter, thereby providing an indication of the urgency of the call to the user or to help the user find the communication unit.

12. The communication unit according to claim 11, wherein the predefined parameter is (1) the second call arriving at the communication unit within a predetermined amount of time, (2) a proper password entered by the caller after the first call or (3) the caller being an entry in a pre-approved list of the communication unit.

13. The communication unit according to claim 12, wherein the pre-approved list is a contact list of the communication unit.

14. The communication unit according to claim 12, wherein the processor comprises a comparator module for calculating a time gap between the first call and the second call and comparing the time gap with the predetermined amount of time.

15. The communication unit according to claim 11, wherein the processor is further programmed to transfer the first call to an answering system, which notifies the caller that an alert level will be modified if the second call from the caller meets the predefined parameter.

16. The communication unit according to claim 11, further comprising a memory module for storing call details of the first call, wherein the call detail comprises identity of the caller and time of call.

17. The communication unit according to claim 11, wherein the alert mechanism is a ringer and is modified by increasing the volume of the ringer or by changing a style of a ring-tone that the ringer plays.

18. The communication unit according to claim 11, wherein the alert mechanism is a ringer and is modified by adjusting the state of the ringer from a silent mode to a ringing mode.

19. The communication unit according to claim 11, wherein the alert mechanism is a vibrator and is modified by adjusting the state of the vibrator from a silent mode to a vibrate mode.

20. A machine readable storage, having stored thereon a computer program having a plurality of code sections executable by a communication unit for causing the communication unit to:
receive a first call from a caller;
receive a subsequent second call from the caller; and
if the second call meets a predefined parameter, increase an alert level of the communication unit to provide an indication of the urgency of the call or to locate the communication unit.
